(19) United States
(12) Patent Application Publication
(10) Pub. No.: US 2012/0248395 A1
(43) Pub. Date: Oct. 4, 2012

(54) FALL-RISK-REDUCTION METHOD AND APPARATUS

(76) Inventors: Donna Raye Stark, Albuquerque, NM (US); Joe G. Hoffman, Santa Fe, NM (US)

(21) Appl. No.: 13/366,953

(22) Filed: Feb. 6, 2012

Related U.S. Application Data
(60) Provisional application No. 61/439,408, filed on Feb. 4, 2011.

(51) Int. Cl. E04F 11/18; B23P 11/00

(52) U.S. Cl. 256/59; 29/428

(57) ABSTRACT

Disclosed herein is a method for reducing the risk of a fall comprising the steps of: attaching to a stable fixture a generally-tubular handrail with a plurality of vertical sections interposed by a plurality of horizontal sections, wherein ones of said multiple horizontal sections are positioned at at least two different vertical heights. The method also comprises assessing desired or optimal grasp locations along said handrail. Anti slip devices are preferably attached to the handrail adjacent the grasp locations. Also disclosed is a fall-risk reduction device comprising a generally-tubular handrail with a plurality of vertical sections interposed by a plurality of horizontal sections. The fall-risk reduction device also includes a plurality of antislip rings adjustably attached around said handrail and having a diameter approximately ½ inches larger than the diameter of said handrail.

### CROSS-REFERENCE

Priority is claimed from U.S. Provisional Patent Application 61/439,408, filed Feb. 4, 2011, which is hereby incorporated by reference.

### BACKGROUND

The present application relates to fall-risk reduction methods and devices, and more particularly to methods, devices, and systems for installing and customizing handrails for bathrooms and the like.

Note that the points discussed below may reflect the hindsight gained from the disclosed inventions, and are not necessarily admitted to be prior art.

Significant numbers of people born after WWII (baby boomers) are approaching senior citizen status. Coupled with those handicapped for other reasons (such as disabled veterans) there is an increasing need for ergonomically-correct handrails, particularly in bathroom facilities, to assist these individuals to live independently and avoid injury.

Handrails for the assistance of handicapped individuals in private and public bath facilities have been in existence for decades. These rails typically consist of a single bar, 1 to 2 inches in diameter, and are primarily mounted horizontally in proximity to a toilet, shower, bathtub, or the like.

In some cases, primarily for use with bathtub/shower combinations, the rails are mounted either diagonally or vertically. These rails provide for stability, but are ergonomically inefficient to assist in raising and lowering the body, or transferring to a wheel chair. These rails are often difficult to use or become useless with the combination of body weight and wet hands.

Consider the motions involved in moving from a sitting to a standing position: 1) the body mass must be moved forward to be at least partially above the legs, 2) the body mass must then be moved upward and forward to be above the legs, and 3) the body mass can then be raised to the standing position with the legs. The same general steps are performed in reverse when moving from a standing to sitting position. Movement from a laying or reclined position (e.g. in a bathtub) requires additional steps including upward movement of the torso to a generally-vertical position.

Each of these motions requires support in a different direction. Further, each movement is optimized by grasping in a different location. Additionally, while the typical cylindrical handrail provides generally adequate grasping ability in a direction perpendicular to the rail, many forces are applied in directions other than perpendicular. When force is applied in a direction other than perpendicular, cylindrical rails are prone to grip slippage, especially when wet.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 shows a fall-risk reduction device.

FIG. 2 is a close view of an anti-slip ring for a fall-risk-reduction device.

FIG. 3 is a close view of a mounting flange for a fall-risk-reduction device.

FIGS. 4A-4D are flow charts illustrating procedures for installation of a fall-risk-reduction device.

FIG. 5A is a flow chart illustrating a method of customizing a fall-risk-reduction device to minimize the risk of falling and maximize assistance provided to a user.

FIGS. 5B and 5C illustrate two steps in the method of FIG. 5A.

FIG. 6 shows another embodiment for a fall-risk-reduction device.

FIG. 7 shows another embodiment for a fall-risk-reduction device.

FIG. 8 shows another embodiment for a fall-risk-reduction device.

### DETAILED DESCRIPTION OF SAMPLE EMBODIMENTS

The present application discloses novel methods, devices, and systems for fall-risk reduction. A handrail is provided with a plurality of vertical sections interposed by a plurality of horizontal sections, wherein ones of said sections are positioned at two or more vertical heights and/or horizontal positions. An optimal position for the handrail is determined and the handrail is secured to a stable surface or object. Desired or optimal grasp locations along said handrail are assessed. Anti-slip devices are preferably attached to the handrail at or adjacent the grasp locations.

In one class of embodiments, anti slip devices comprise rings configured to encircle the handrail. An outer diameter of the ring is preferably at least ½″ larger than a diameter of the handrail.

In another class of embodiments, anti slip devices comprise generally-cylindrical handles attached around or to the handrail.

In another class of embodiments, optimal grasp locations are assessed by positioning a user near a location of likely use, having the user grasp the handrail at one or more natural and comfortable location, and marking the grasp location.

The disclosed innovations, in various embodiments, provide one or more of at least the following advantages. However, not all of these advantages result from every one of the innovations disclosed, and this list of advantages does not limit the various claimed inventions.
Ability to grasp a handrail at a variety of locations and orientations;
Reduction of risk of hand slippage along handrail;
Facilitates easy entry and exit from bathroom equipment;
Provides optimal grasping locations for specific users;
Handrail can be installed securely;
Simple operation by user;
Easy custom installation;
No or minimal moving parts;
Handrail is effective without being intrusive;
Simple construction and manufacturability.

The numerous innovative teachings of the present application will be described with particular reference to presently preferred embodiments (by way of example, and not of limitation). The present application describes several inventions, and none of the statements below should be taken as limiting the claims generally.

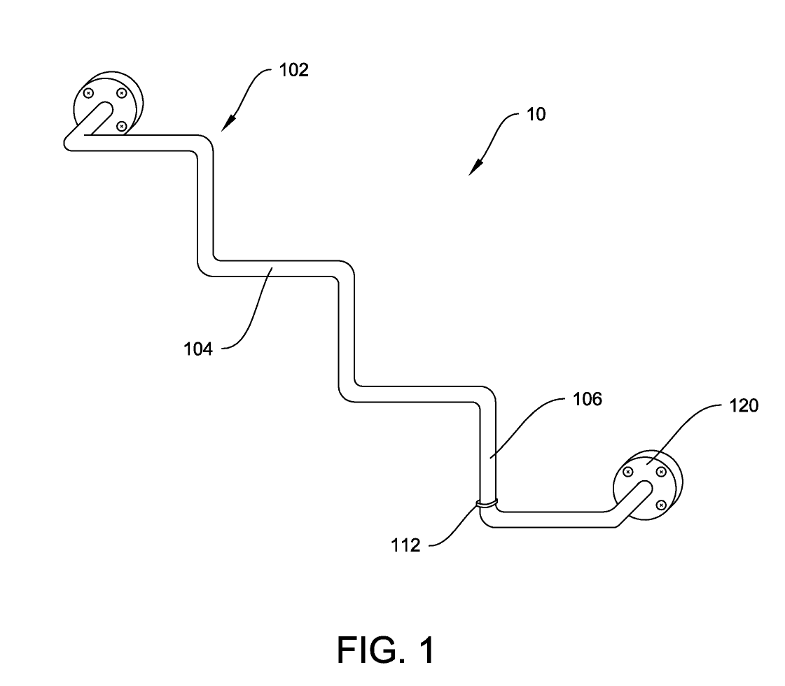

FIG. 1 shows an embodiment of a fall-risk-reduction device (“FRRD”) 10. FRRD 10 comprises a handrail 102. Handrail 102 is shown in FIG. 1 as a round tube with an outer diameter of about 1.25 inches. Other geometries for a handrail 102 can be used, such as tubes with square, oval, or other cross sections, or bars or rods. Handrail 102 is preferably constructed from stainless steel, which is durable, corrosion-resistant, and aesthetically pleasing. Alternatively, many other materials can be used for handrail 102 such as many metals, woods, plastics, or plastic composites, with suitable corrosion and anti-slip protection.

Handrail 102 comprises a plurality of alternating horizontal sections 104 and vertical sections 106. Horizontal sections 104 are oriented and positioned to optimize assistance to users applying force in generally upward or downward directions. Vertical sections 106 are oriented and positioned to optimize assistance to users applying force in a generally horizontal direction.

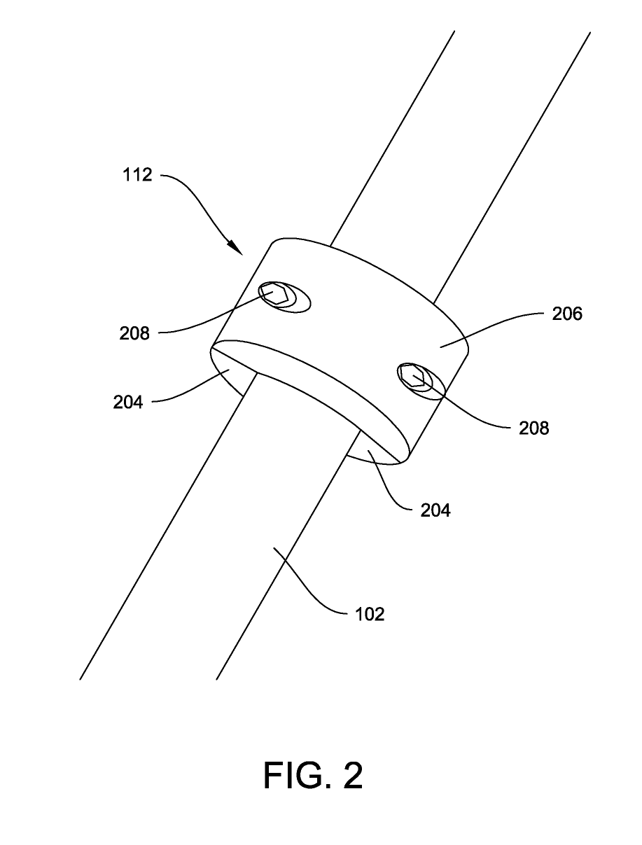

Because force will often be applied in a direction other than directly vertical or horizontal, anti-slip devices 112 are preferably securely attached to handrail 102. FIG. 2 illustrates an embodiment of an anti-slip device 112 in the form of a ring 202. Ring 202 preferably comprises a first half 204 and a second half 206 which connect to encircle handrail 102. Attachment screws 208 are used to hold first half 204 and second half 206 securely to handrail 102. Ring 202 preferably has an outer diameter that is about ½″ larger than the outer diameter of handrail 102. A diameter at least ½″ larger than the outer diameter of handrail 102 decreases the likelihood that a grasp slippage will result in the user's hand moving along the rail past ring 202.

FRRD 10 preferably comprises a plurality of mounting flanges 120 to facilitate secure attachment of FRRD 10 to a wall or other surface. Most preferably, a mounting flange 120 is provided at or near each end of handrail 102. For longer handrails 102 additional mounting flanges can be positioned along handrail 102. Mounting flanges 120 can be: constructed as a single unit with handrail 102; permanently attached to handrail 102 (e.g. by welding); removably attachable to handrail 102 (e.g. by threads), or attached by other method.

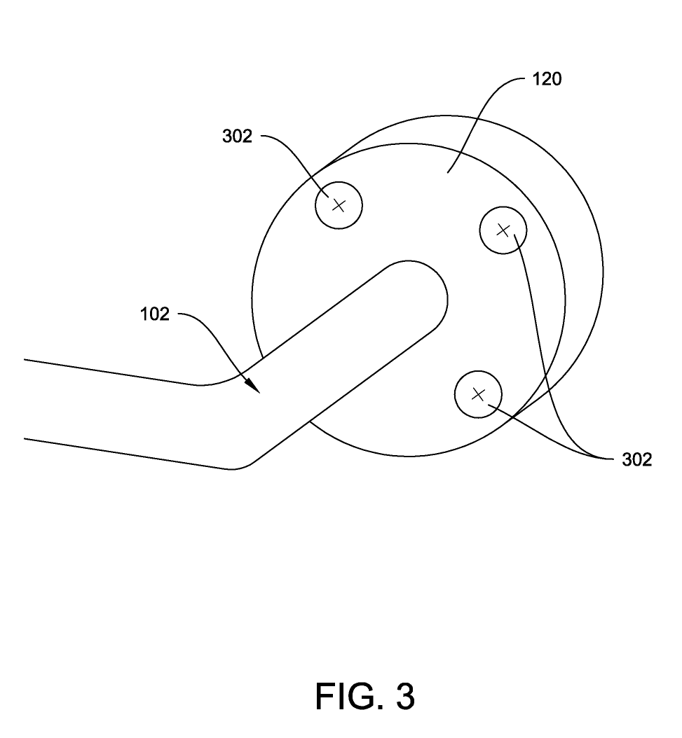

FIG. 3 is a close-up view of mounting flange 120. Mounting flange 120 preferably comprises a plurality of screw holes 302 which facilitate secure attachment to a mounting surface. Mounting flange 120 illustrated in FIG. 3 is preferably designed to be both strong and aesthetically pleasing. Alternatively, a strong mounting flange 120 can be used without regard to aesthetics and the flange can be covered by an aesthetically-pleasing cover (not shown).

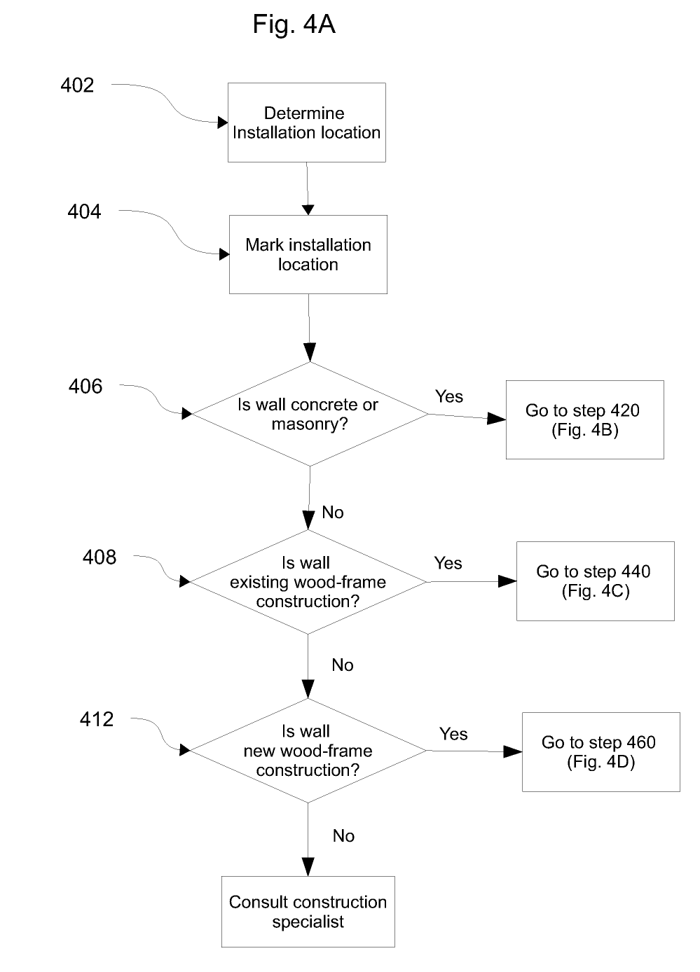

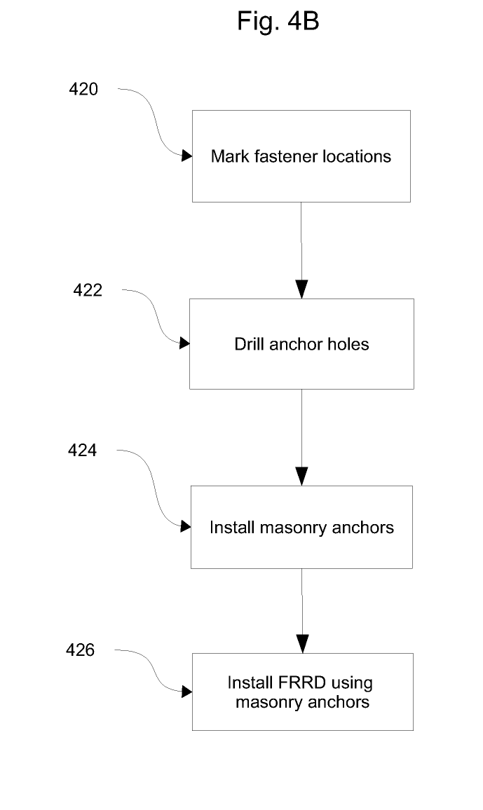

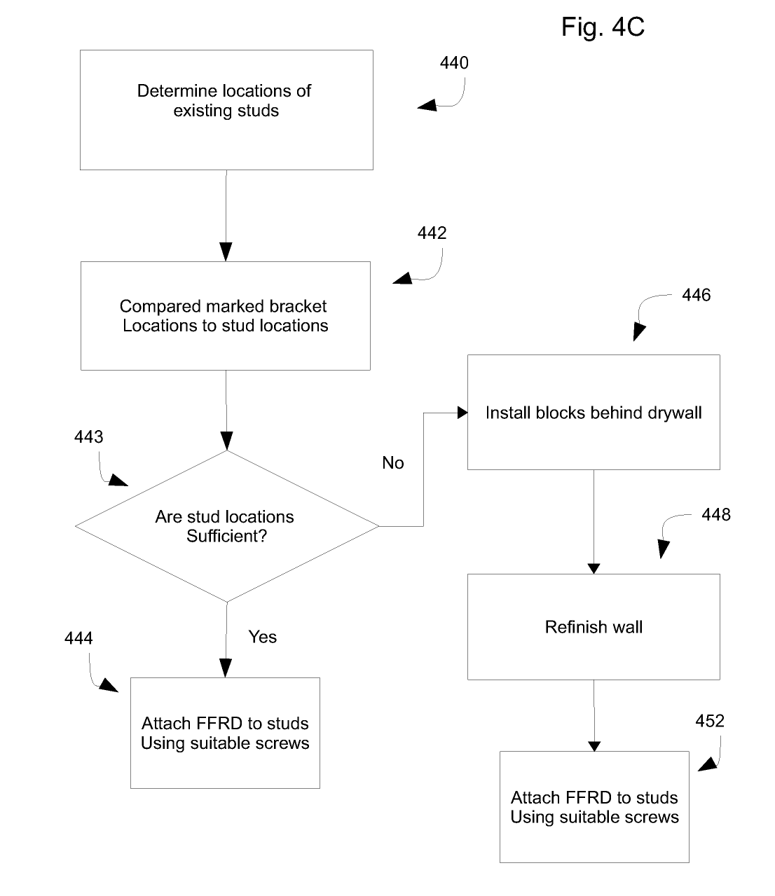

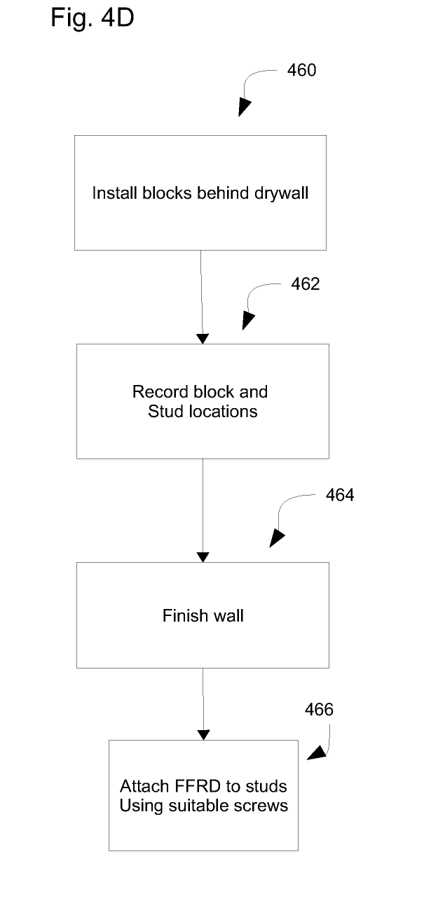

FIG. 4A illustrates one process for installation of FRRD 10. First, in step 402, an installation location for FRRD 10 is chosen. The installation location is chosen at a position such that multiple vertical sections 106 and/or horizontal sections 104 will be within reach of a user when assistance is needed. In step 404, the chosen installation location is preferably marked on the wall or other surface.

In step 406, the installer determines if the wall is concrete or masonry. If so, the installer proceeded to step 420 of FIG. 4B. If not, then, in step 408, the installer determines if the wall is conventional frame construction. If so, proceed to step 440 of FIG. 4C. For new construction, proceed to step 460 of FIG. 4D.

In step 420, fastener locations are marked on the wall. In step 422, anchor holes are preferably drilled into the concrete or masonry. In step 424, suitable masonry anchors are installed into the anchor holes. In step 426, FRRD 10 is preferably attached to the wall by screws or other fasteners placed in the masonry anchors.

For conventional wood-frame wall installation, in step 440, the installer determines the location of studs. In step 442, the installer compares the previously-marked bracket location with the stud locations and determines whether FRRD 10 can be securely affixed to the studs. If yes, FRRD 10 is attached to the studs with suitable screws in step 444. If stud locations are determined in step 442 to be inadequate, then, in step 446, the installer preferably removes a portion of the wall and installs blocks (e.g. by attaching cross beams between adjacent studs at the desired attachment locations) to provide secure mounting points. In step 448, the installer re-finishes the wall. In step 452, the installer secures FRRD 10 to the blocks with suitable screws.

For installation on a new wall (e.g. in new construction or as part of a major remodel), in step 460, blocks are installed between wall studs, if necessary, at FRRD 10 attachment locations. In step 462, blocking locations are recorded for future reference. In step 464, the wall is finishing according to conventional methods. In step 466, FRRD 10 is attached to the wall at blocks or studs using appropriate screws.

In cases where an FRRD 10 is being installed on a wall that is not conventional frame construction or concrete/masonry, a knowledgeable construction expert should be consulted to determine appropriate installation methods. The installation must be sufficiently secure to withstand repeated application of force associated with an adult human.

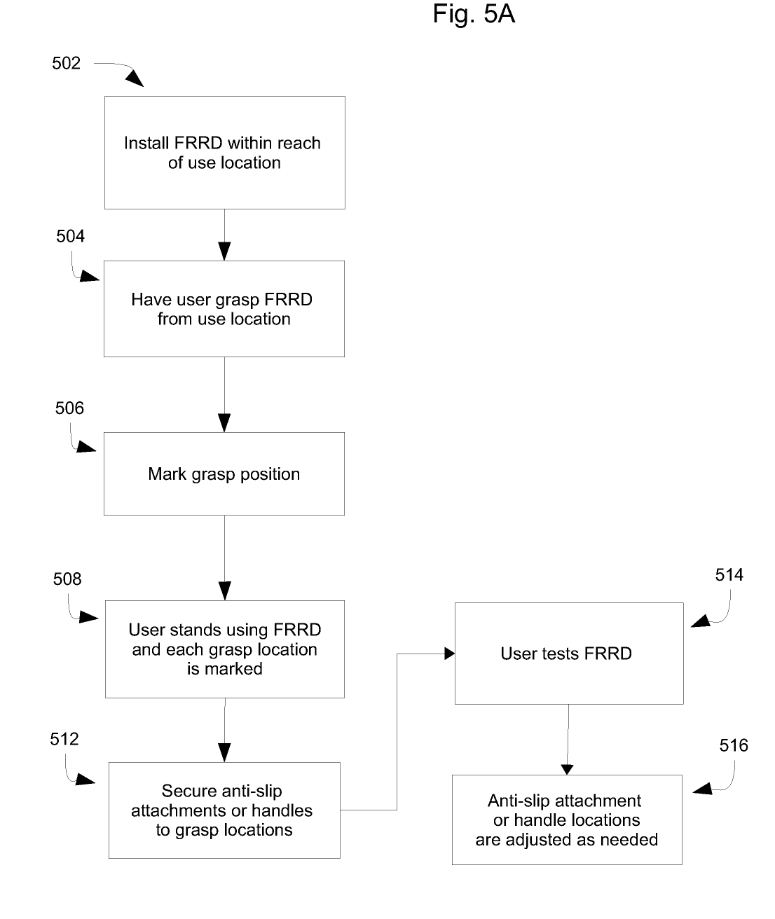

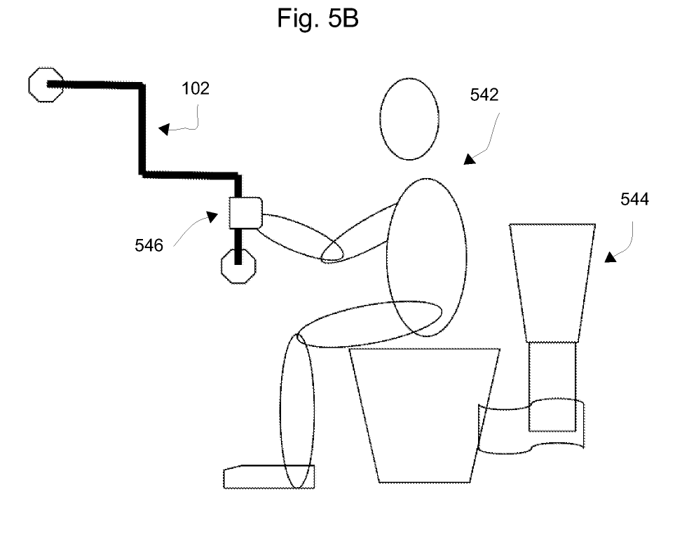

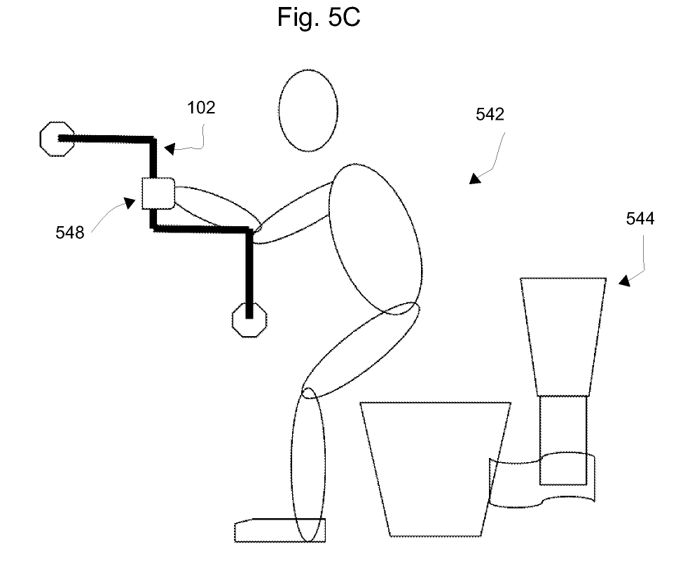

Preferably, anti-slip devices 112 are adjustable and are installed at custom positions optimized for a particular user. FIG. 5A illustrates one procedure for assessing optimal grasp locations. In step 502, FRRD 10 is installed in the use location at a position such that multiple vertical sections 106 and/or horizontal sections 104 will be within reach of a user when assistance is needed. Next, in step 504 (see FIG. 5B) the user 542, while positioned in a location where assistance may be needed, such as on a toilet 544 or in a bathtub (not shown), grasps handrail 102 at a comfortable position. In step 506, the grasp position 546 is marked by the installer.

In step 508 (see FIG. 5C), the user 542 preferably then grasps handrail 102 at subsequent natural locations as necessary (e.g., until standing) and each grasp location 548 is marked. The installer or another person should assist the user during this process.

In step 512, the installer secures anti-slip devices 112 into position based on the marked grasp locations. In step 514 (see FIG. 5D), after securing anti-slip devices 112 to handrail 102, the user 442 preferably uses handrail 102, with assistance, to move from a standing to lowered position and back to standing. In step 516, necessary adjustments to anti-slip devices 112 positions are made and/or additional anti-slip devices 112 are added.

Alternatively to, or in addition to the procedure illustrated in FIG. 5A, optimal positions for anti-slip devices can be based on advice from the user's doctor, physical therapist, or other qualified person.

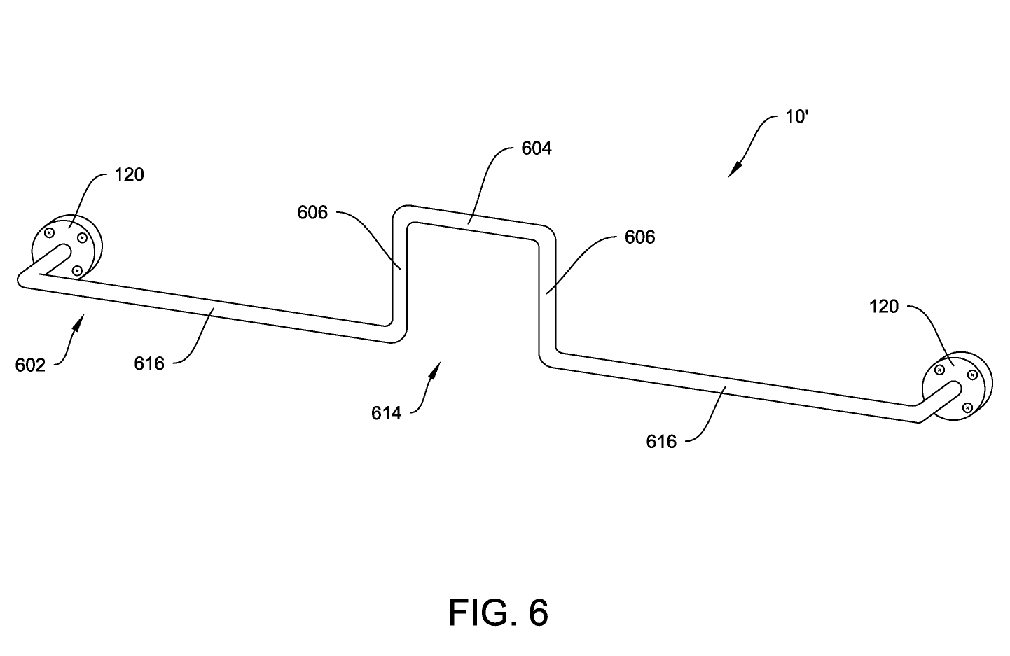

Alternatively to using a handrail with adjustable anti-slip devices 112, the installer can select a handrail with anti-slip devices pre-position positioned at locations which are advantageous for a particular user and location combination. This can be done with input from the user or specifications from a health care specialist. For example, it has been found that, for and FRRD 10 intended for use next to a toilet, one advantageous design includes anti-slip devices 112 on two different vertical sections 106. The two different vertical sections are preferable spaced 6″ to 12″ away from each other horizontally. Most preferably for this embodiment, the anti-slip devices on two different vertical sections are positioned at the same vertical height. This arrangement can be achieved using handrails with a “horseshoe” configuration (see FIG. 6) or other configurations.

FIG. 6 illustrates another embodiment of an FRRD 10′. FRRD 10′ comprises a handrail 602 with a horseshoe formation 614 composed of a horizontal section 604 and two vertical sections 606. Preferably, handrail 602 comprises one or more additional horizontal section 616 extending from horseshoe formation 614. Other aspects of FRRD 10′, including anti-slip devices 112, are generally similar to FRRD 10 described above.

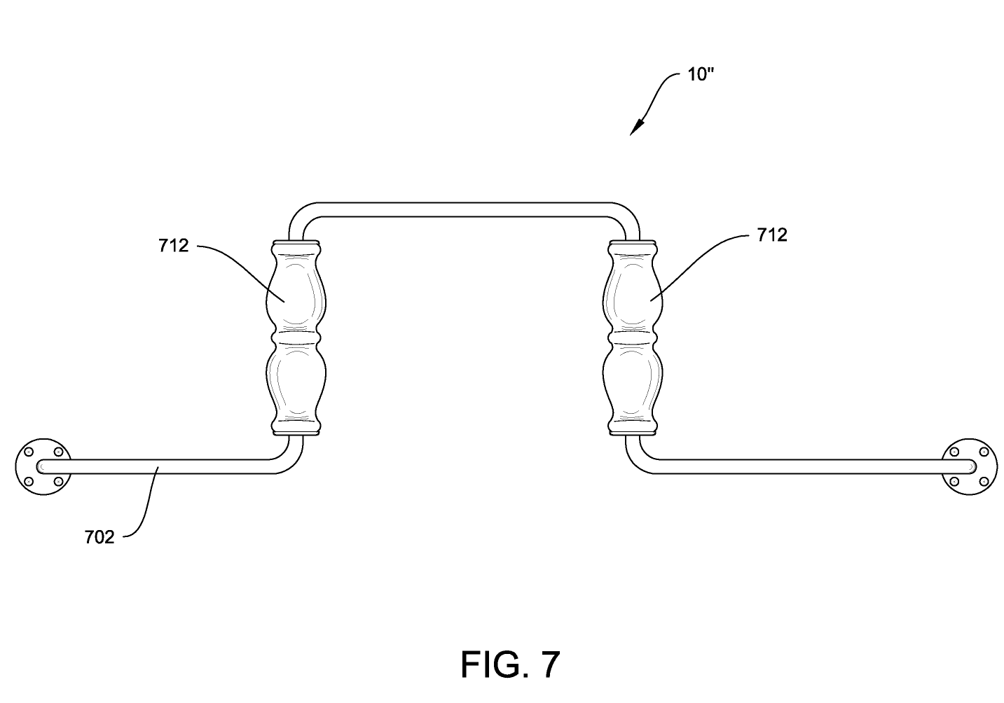

FIG. 7 illustrates another embodiment of FRRD 10″. FRRD 10″ comprises a rod-like handrail 702 in place of a tubular handrail. Handrail 702 has a diameter smaller than what is optimal for grasping. Accordingly, handles 712 are preferably used as anti-slip devices instead of rings. Handles 712 preferably have an outer diameter of about 1.25 inches. Handles 712 preferably comprise a slip-resistant material or are shaped to reduce the risk of grip slipping. Handles 712 can be attached to to handrail 702 by clamping, welding, gluing, or other methods, or can be cast or machined onto handrail 702. FRRD 10″ is shown with certain ornamental features which are not required to practice the claimed inventions.

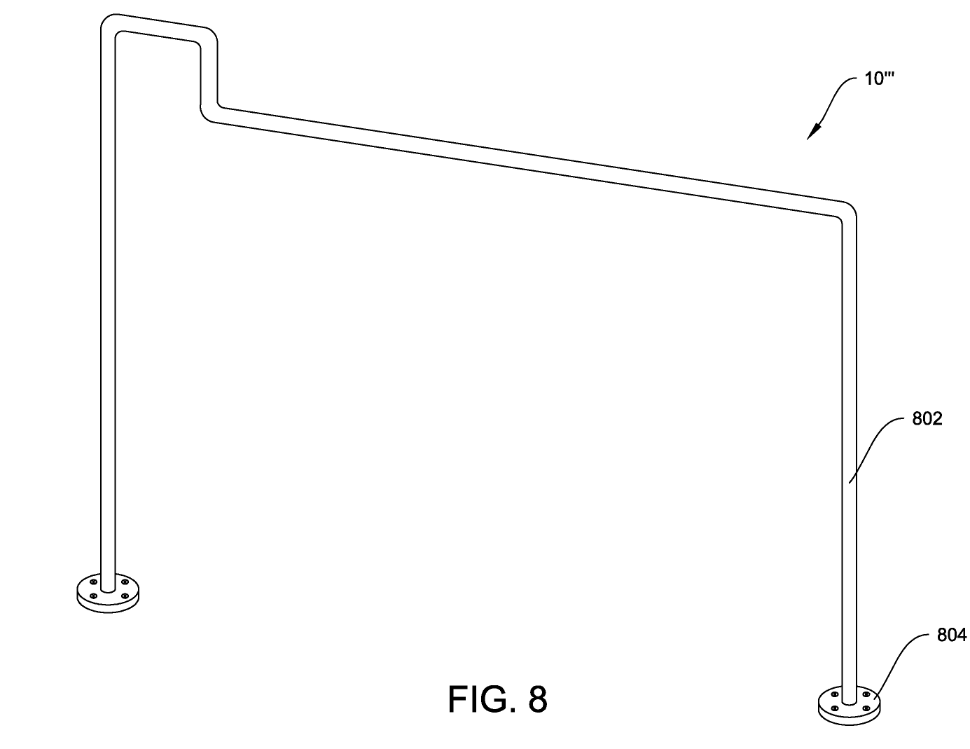

FIG. 8 illustrates another embodiment of FRRD 10″. FRRD 10′″ comprises a tubular handrail 802. Handrail 802 is configured to attach to a floor near a location of expected need. Floor mounting flanges 804 are configured to secure handrail 802 to the floor. Floor mounting flanges 804 are similar to mounting flanges 120. However, floor mounting flanges 804 are preferably larger and stronger than mounting flanges 120 because of the potential large forces resulting from the longer lever arm of handrail 802.

According to some but not necessarily all embodiments, there is provided:

A method for installing a risk reduction device, comprising, in any order, the actions of: attaching a substantially-continuous handrail to a stable surface near a location of expected use; wherein said handrail comprises a plurality of substantially-vertical segments interposed by a plurality of substantially-horizontal segments; and wherein the plurality of horizontal segments are positioned at at least two different vertical heights; assessing desired grasp locations for one or more prospective user; and attaching anti-slip devices, adjoining said desired grasp locations.

A method for installing a risk reduction device, comprising, in any order, the actions of: assessing optimal grasp locations along a handrail for a user based on user size, intended location, and intended use; obtaining a handrail with anti-slip devices at or near said optimal grasp locations; wherein said handrail comprises a plurality of substantially-vertical segments interposed by a plurality of substantially-horizontal segments; and wherein the plurality of vertical segments are configured to be positioned at at least two horizontal positions when installed to a stable surface; attaching said handrail to a secure surface near an expected location of need at a position easily reachable by said user.

A fall-risk-reduction device, comprising: a substantially-continuous handrail, wherein said handrail comprises a plurality of substantially-vertical segments which are separated by a plurality of substantially-horizontal segments; and wherein the plurality of horizontal segments are configured to be positioned at at least two different vertical heights when installed; and antislip devices adjustably attachable to said handrail and configured to reduce the risk of grip slippage along said handrail.

A fall-risk-reduction device, comprising: a substantially-continuous handrail, wherein said handrail comprises a plurality of substantially-vertical segments which are separated by a plurality of substantially-horizontal segments; and wherein the plurality of horizontal segments are configured to be positioned at at least two different vertical heights when installed; and antislip devices attached to said handrail on at least two of said substantially-vertical segments.

A method for reducing the risk of a fall comprising the steps of: attaching to a stable fixture a generally-tubular handrail with a plurality of vertical sections interposed by a plurality of horizontal sections, wherein ones of said multiple horizontal sections are positioned at at least two different vertical heights. The method also comprises assessing desired or optimal grasp locations along said handrail. Anti slip devices are preferably attached to the handrail adjacent the grasp locations. Also disclosed is a fall-risk reduction device comprising a generally-tubular handrail with a plurality of vertical sections interposed by a plurality of horizontal sections. The fall-risk reduction device also includes a plurality of antislip rings adjustably attached around said handrail and having a diameter approximately ½ inches larger than the diameter of said handrail.

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Anti-slip devices can alternatively include handles extending outwardly from a handrail, self adhesive attachments, handles surrounding handrail, handles screwed onto the handrail, cast collars, texture defined on the handrail surface, non-slip tape, and the like. Anti-slip devices can comprise any material which is rugged enough to withstand repeated use and is capable of reducing the risk of user grip slippage, such as rubber, metal, polymers, wood and fiber-reinforced polymer.

Anti-slip devices can be retrofitted to existing installations using some of the methods described herein.

Anti-slip device can be attached by clamping, welding, gluing, threading, adhesive tape, or other methods. Anti-slip devices can alternatively be defined on handrail by machining or casting.

Handrails can comprise tubes, rods, bars, beams, and the like. Handrails can be manufactured out of steel (preferably painted or powder-coated), stainless steel, brass, aluminum, wood, plastic, fiber-reinforced polymer, or other materials. Handrails can have a decorated surface, such as decorative texturing or painting.

Handrails can be mounted to a wall or other surface by screws, suitable wall anchors, direct attachment to studs, by gluing directly to the surface, or by other methods offering sufficient strength.

Handrails can comprise user or installer-configurable sections (such as straight portions and elbow joints) to allow customizable combinations of horizontal, vertical, and other handrail section orientations.

The FRRD can comprise hinged sections capable of providing additional support in a location when necessarily and capable of being swung or folded into a stowage position when not needed.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method for installing a risk reduction device, comprising, in any order, the actions of:
attaching a substantially-continuous handrail to a stable surface near a location of expected use;
wherein said handrail comprises a plurality of substantially-vertical segments interposed by a plurality of substantially-horizontal segments; and wherein the plurality of horizontal segments are positioned at at least two different vertical heights;
assessing desired grasp locations for one or more prospective user; and
attaching anti-slip devices, adjoining said desired grasp locations.

2. The method of claim 1 wherein said handrail is substantially-tubular with a circular cross-section and a diameter between 1.25 and 1.5 inches.

3. The method of claim 1 wherein said plurality of vertical and horizontal sections are arranged in a substantially “stairstep” arrangement, so that each subsequent horizontal section is higher than a preceding horizontal section.

4. The method of claim 1 wherein at least two horizontal sections are at the same vertical height and are separated by two vertical and one horizontal section to form a “squared horseshoe” arrangement in said handrail.

5. The method of claim 1 wherein the anti-slip devices comprise one or more ring encircling said handrail, wherein said ring has a diameter at least 0.5 inches greater than a diameter of said handrail.

6. The method of claim 1 wherein said anti-slip devices comprise handles attached around said handrail.

7. The method of claim 1 wherein said handrail comprises a rod with a diameter of less than 0.75 inches and wherein said anti-slip devices comprise generally-cylindrical handles.

8. The method of claim 7 wherein said rod is powder-coated steel configured to have the appearance of wrought iron.

9. The method of claim 1 wherein the step of assessing desired grasp locations comprises the steps of:
having a user positioned in the location of intended use grasp the handrail at one or more comfortable position; and
marking said grasp position.

10. The method of claim 1 wherein the step of assessing desired grasp locations comprises the additional step of obtaining the advice of a physician, physical therapist, or other qualified medical expert.

11. A method for installing a risk reduction device, comprising, in any order, the actions of:
assessing optimal grasp locations along a handrail for a user based on user size, intended location, and intended use;
obtaining a handrail with anti-slip devices at or near said optimal grasp locations; wherein said handrail comprises a plurality of substantially-vertical segments interposed by a plurality of substantially-horizontal segments; and wherein the plurality of vertical segments are configured to be positioned at at least two horizontal positions when installed to a stable surface;
attaching said handrail to a secure surface near an expected location of need at a position easily reachable by said user.

12. The method of claim 11 wherein said handrail is substantially-tubular with a circular cross-section and a diameter between 1.25 and 1.5 inches.

13. The method of claim 12 wherein said plurality of vertical and horizontal sections are arranged in a substantially “stairstep” arrangement, so that each subsequent horizontal section is higher than a preceding horizontal section.

14. The method of claim 12 wherein at least two horizontal sections are at the same vertical height and are separated by two vertical and one horizontal section to form a “squared horseshoe” arrangement in said handrail.

15. The method of claim 12 wherein the anti-slip devices comprise one or more ring encircling said handrail, wherein said ring has a diameter at least 0.5 inches greater than a diameter of said handrail.

16. The method of claim 12 wherein said anti-slip devices comprise handles placed around said handrail.

17. The method of claim 12 wherein said anti-slip devices are defined on said handrail during manufacture of said handrail.

18. The method of claim 12 wherein said handrail comprises a rod with a diameter of less than 0.75 inches and wherein said anti-slip devices comprise generally-cylindrical handles.

19. The method of claim 18 wherein said rod is powder-coated steel configured to have the appearance of wrought iron.

20. (canceled)

21. A fall-risk-reduction device, comprising:
a substantially-continuous handrail,
wherein said handrail comprises a plurality of substantially-vertical segments which are separated by a plurality of substantially-horizontal segments; and wherein the plurality of horizontal segments are configured to be positioned at at least two different vertical heights when installed; and
antislip devices adjustably attachable to said handrail and configured to reduce the risk of grip slippage along said handrail.

22.-38. (canceled)
